(19) United States
(12) Patent Application Publication
(10) Pub. No.: US 2012/0271951 A1
(43) Pub. Date: Oct. 25, 2012

(54) CONTROL METHOD FOR PROVIDING STORAGE SPACE OF APPLICATION AND TERMINAL AND SERVER THEREFOR

(75) Inventors: Jin-Suk LEE, Suwon-si (KR); Yoon-Chan Choi, Suwon-si (KR); Kyoung-Yong Lee, Suwon-si (KR)

(73) Assignee: Samsung Electronics Co., Ltd., Suwon-si (KR)

(21) Appl. No.: 13/450,980

(22) Filed: Apr. 19, 2012

Related U.S. Application Data
(60) Provisional application No. 61/477,012, filed on Apr. 19, 2011.

(30) Foreign Application Priority Data
Apr. 17, 2012 (KR) 10-2012-0039620

(51) Int. Cl. G06F 15/173

(52) U.S. Cl. 709/226

(57) ABSTRACT

Methods and apparatus are provided that provides an external storage space of an application executed in the terminal. Registration information of a user is received through the application via an application registration request of the user. A registration request message is transmitted to a server preset for the application. The registration request message requests allocation of a storage space for the user in the server according to the registration information. The storage space corresponds to the application. A registration completion message is received from the server. The user is informed of completion of an application registration through the application, when the registration completion message is received from the server.

### PRIORITY

This application claims priority under 35 U.S.C. §119 to a U.S. Provisional Patent Application Ser. No. 61/477,012, which was filed in the USPTO on Apr. 19, 2011, and Korean Patent Application Serial No. 10-2012-0039620, which was filed in the Korean Intellectual Property Office on Apr. 17, 2012, the disclosures of which are incorporated herein by reference.

### BACKGROUND OF THE INVENTION

1. Field of the Invention

The present invention relates generally to a method and an apparatus for providing a storage space of an application, and more particularly to a method and an apparatus for providing a storage space outside a terminal for a user of an application, which is executed in the terminal.

2. Description of the Related Art

In general, applications refer to various types of application programs installed and used in terminals, such as, for example, a desktop computer, a tablet computer, and a smart phone. The applications may be installed in the terminal by a manufacturer or a seller of the terminal. However, if desired applications are not installed in the terminal, the user can download the desired applications from outside of the terminal and install the downloaded applications in the terminal. Further, multiple users can use a single application in their respective terminals, and a single user can use various types of applications in its respective terminal.

Among those applications executed in the terminal exist applications that use a storage space of a particular server located outside of the terminal. Such applications store users' data in the storage space of the server and enable the users to access the storage space.

However, in order for users using a single application or users using various applications to share user information, the application is required to interwork with an external cloud computing service, which provides the low-level functionality of a server or a DataBase (DB) level.

Accordingly, it may be complicated to implement applications that allow for the sharing of user information between users of the applications. Therefore, application developers may experience difficulties in developing the applications.

### SUMMARY OF THE INVENTION

The present invention has been made to address at least the above problems and/or disadvantages and to provide at least the advantages described below. Accordingly, an aspect of the present invention provides a control method for easily implementing the user information sharing between users of applications, and a terminal and a server therefore.

Another aspect of the present invention provides a control method for allowing easy access to applications while ensuring security, and a terminal and a server therefore. In accordance with an aspect of the present invention, a control method of a terminal is provided that provides an external storage space of an application executed in the terminal. Registration information of a user is received through the application via an application registration request of the user. A registration request message is transmitted to a server preset for the application. The registration request message requests allocation of a storage space for the user in the server according to the registration information. The storage space corresponds to the application. A registration completion message is received from the server. The user is informed of completion of an application registration through the application, when the registration completion message is received from the server.

In accordance with another aspect of the present invention, a control method of a server is provided that provides an external storage space of an application executed in a terminal. The server is preset for the application. A registration request message is received from the terminal. The registration request message includes registration information of a user of the application. The user is registered according to the registration information such that the user corresponds to the application. A storage space is generated for the user in a storage such that the storage space corresponds to the application. A registration completion message is transmitted to the terminal. The registration completion message indicates completion of registration of the user corresponding to the application.

In accordance with another aspect of the present invention, a terminal is provided that provides an external storage space of an application executed in the terminal. The terminal includes a communication unit for providing communication to a preset server for the application. The terminal also includes a controller for receiving registration information of a user through the application via an application registration request of the user, transmitting a registration request message to the preset server through the communication unit, wherein the registration request message requests allocation of a storage space for the user in the server according to the registration information, and wherein the storage space corresponds to the application, receiving a registration completion message from the server through the communication unit, and informing the user of completion of an application registration through the application when the registration completion message is received from the server.

In accordance with another aspect of the present invention, a server is provided that provides a storage space of an application executed in a terminal. The server is preset for the application. The server includes a communication unit for providing communication to the terminal, and a storage for providing the storage space of the application. The server also includes a controller for receiving a registration request message from the terminal through the communication unit, wherein the registration request message includes registration information of a user of the application, registering the user according to the registration information such that the user corresponds to the application, generating the storage space for the user in the storage, and transmitting a registration completion message to the terminal through the communication unit, wherein the registration completion message indicates completion of registration of the user corresponding to the application.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating a system for providing a storage space of an application, according to an embodiment of the present invention;

FIG. 2 is a block diagram illustrating a terminal, according to an embodiment of the present invention;

FIG. 3 is a block diagram illustrating a server, according to an embodiment of the present invention;

FIG. 4 is a flowchart illustrating a storage space generation methodology, according to an embodiment of the present invention;

FIG. 5 is a diagram illustrating storage space generation, according to an embodiment of the present invention;

FIG. 6 is a table showing a database, according to an embodiment of the present invention; and

FIG. 7 is a flowchart illustrating a storage space access methodology, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Further, various definitions found in the following description are provided only to help general understanding of the present invention, and it is apparent to those skilled in the art that the present invention can be implemented without such definitions. Detailed descriptions of constructions or processes known in the art may be omitted to avoid obscuring the subject matter of the present invention.

The terms and words used in the following description and claims are not limited to their dictionary definitions, and are used for the purpose of clear and consistent understanding. Therefore, the terms and words should be defined based on the contents of the description.

Hereinafter, although a mobile terminal is described in embodiments of the present invention, the embodiments of the present invention can be applied to other apparatuses having a similar technical background. Further, the embodiments of the present invention can be applied to other apparatuses through some modifications performed by those skilled in the art without departing from the technical spirit and scope of the present invention. Specifically, the embodiments of the present invention can be applied to a terminal if the terminal executes an application using an external storage space, even if the terminal is not the mobile terminal. For example, embodiments of the present invention can be applied to a desktop computer, a smart Television (TV), etc., if they execute the application using the external storage space. Embodiments of the present invention can also be applied to various portable electronic devices, such as, for example, a Moving Picture Experts Group (MPEG) Audio Layer III (MP3) player, a Portable Multimedia Player (PMP), and a digital camera.

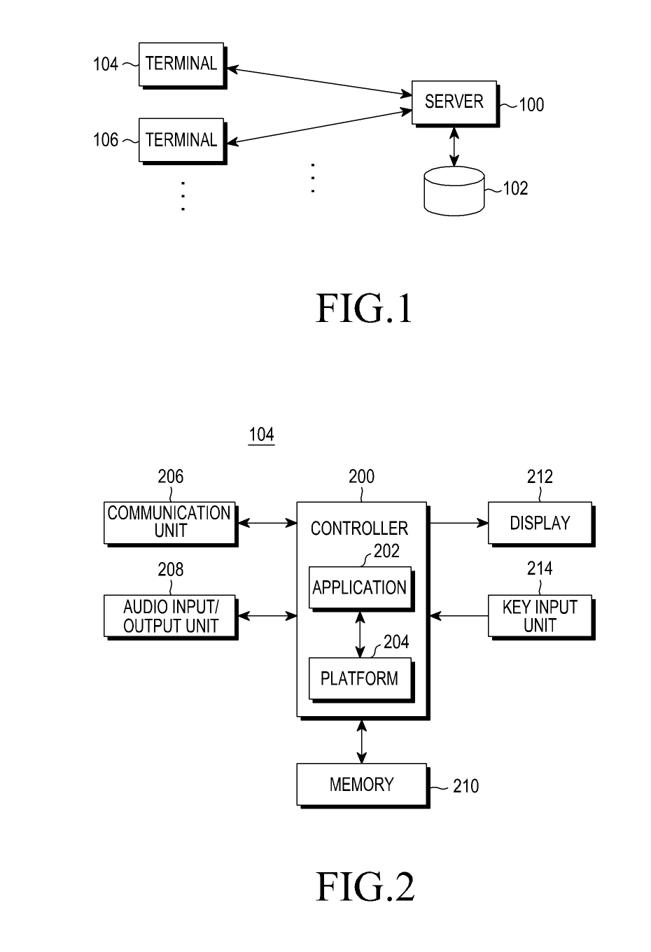

FIG. 1 is a block diagram illustrating a system for providing a storage space of an application, according to an embodiment of the present invention. Referring to FIG. 1, terminals 104 and 106 are connected to a server 100 through wired or wireless communication. The terminals 104 and 106 are allocated storage spaces of terminal applications from the server 100, for users of the applications. The applications are executed in the respective terminals and use external storage spaces. Users of the terminals 104 and 106 can use one or more applications using the external storage space in their terminals. The server 100 generates storage spaces of the applications executed in the terminals 104 and 106 in a storage 102. The storage spaces correspond to the users of the applications. The server 100 allocates the storage spaces corresponding to the applications and the users of the applications. The users of the applications can access the generated storage spaces of the storage 102 through the applications corresponding to the terminals 104 and 106. The storage 102 provides the storage spaces of the applications, which are generated in accordance with a control of the server 100.

Although FIG. 1 illustrates the storage 102 located outside of the server 100, the storage 102 can also be included within the server 100. The server 100 may be a web server. Further, although FIG. 1 illustrates two terminals 104 and 106, the embodiments of the present invention are not limited to a specific number of terminals, which are allocated external storage spaces of the applications by the server 100 and which can access the external storage spaces.

FIG. 2 is a block diagram illustrating a terminal, according to an embodiment of the present invention. Specifically, FIG. 2 illustrates a block diagram of a mobile terminal corresponding to the terminal 104, which is one of the two terminals 104 and 106 illustrated in FIG. 1. The terminal 104 may be, for example, a notebook computer, a tablet computer, a mobile phone, a smart phone, or a PDA. Referring to FIG. 2, the mobile terminal 104 includes a controller 200, a communication unit 206, an audio input/output unit 208, a memory 210, a display 212, and a key input unit 214.

The communication unit 206 provides communication for various communication services of the terminal 104, as well as communication for the server 100, which is under the control of the controller 200. The communication unit 206 includes a mobile communication means, and may further include wired and wireless communication means, such as, for example, a Universal Serial Bus (USB), a Local Area Network (LAN), and a Bluetooth. The audio input/output unit 208 inputs and outputs various audio data according to an operation of the controller 200. The memory 210 stores a program for the operation of the controller 200 and various data according to an execution of the controller 200. The memory 210 may include an external memory and a storage device such as a Hard Disk Drive (HDD). The display 212 displays a video according to the operation of the controller 200. The key input unit 214 receives various key inputs, which are required for operation of the terminal 104, from the user, and provides the various key inputs to the controller 200. The key input unit 214 may include a touch screen panel installed on the display 212, and may also include keys for inputting number and character information, and function keys for setting various functions.

The controller 200 includes an application 202 and a platform 204. Although FIG. 2 illustrates only one application 202, various applications that use the external storage space can be executed by the controller 200 after being installed in the terminal 104. The application 202 and the platform 204 may be stored in the memory 210, and are loaded from the memory and executed by the controller 200. The application 202 is an application program that uses the external storage space. The controller 200 controls a general function of the terminal 104 by the platform 204. The controller 200 is allocated the storage space of the application 202 from the server 100 by the platform 204, and performs a control that enables the user of the application 202 to access the storage space.

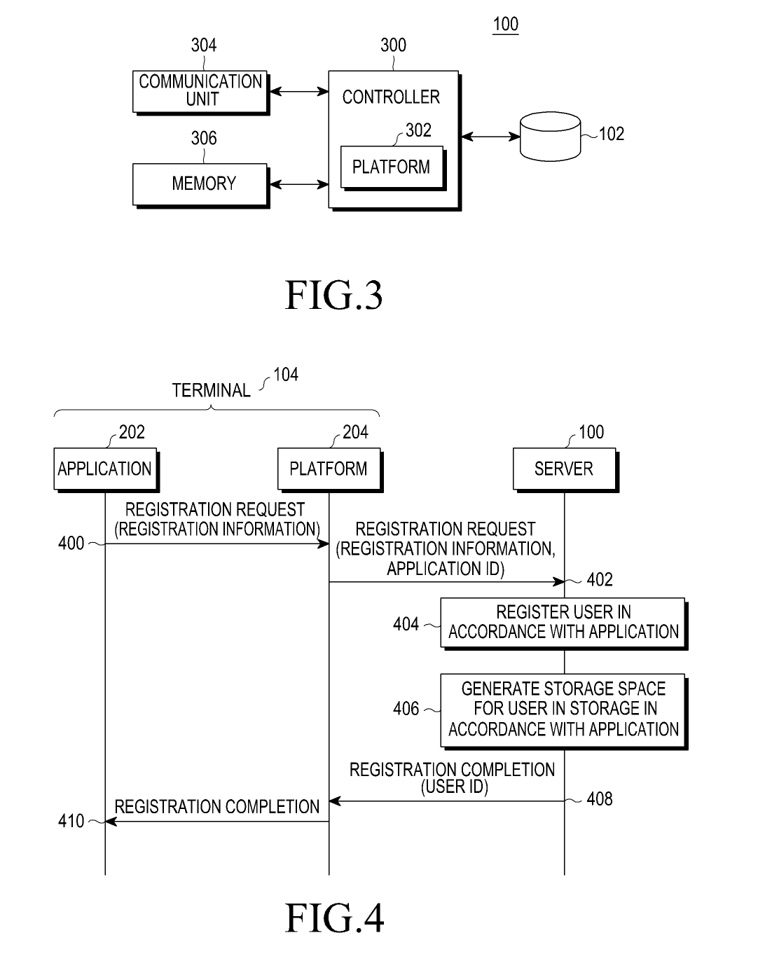

FIG. 3 is a block diagram of the server, according to an embodiment of the present invention. A construction of the server 100 corresponds to an embodiment of the present invention in which the server 100 includes the storage 102. Referring to FIG. 3, the server 100 includes a controller 300, a communication unit 304, a memory 306, and the storage 102.

The communication unit 304 provides communication with the terminals 104 and 106 under a control of the controller 300. The memory 306 stores a program for the operation of the controller 300 and various data according to an execution of the controller 300. The memory 306 may include an external memory and a storage device such as an HDD.

The controller 300 includes a platform 302, which is interworked with the platform 204 of the terminal 104, shown in FIG. 2. The platform 302 may be stored in the memory 306, and may be loaded from the memory 306 and executed by the controller 300. The controller 300 generates the storage space of the application 202 of the terminals 104 and 106 in the storage 102 using the platform 302, and performs a control that enables users of the application 202 to access the storage space.

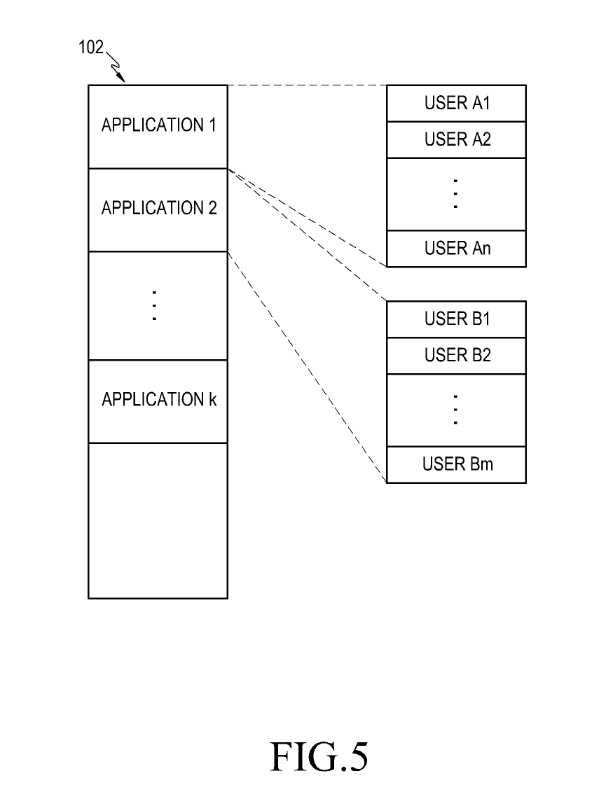

FIG. 4 is a flowchart illustrating a storage space generation methodology, according to an embodiment of the present invention. The flowchart of FIG. 4 shows processes performed between the controller 200 of the terminal 104 and the controller 300 of the server 100, in order to allocate the storage space for the user of the application 202 to the storage 102 after the terminal 104 registers the user of the application 202 in the server 100. Processes performed by the controller 200 of the terminal 104 are divided into processes performed by the application 202 and processes performed by the platform 204, as shown in FIG. 4.

Referring to FIG. 4, when the application 202, which is executed through the controller 200 by the user of the terminal 104, receives an application registration request from the user through the key input unit 214, the application 202 sends a registration request to the platform 204, in step 400. The registration request contains registration information input by the user. The application registration request is a request for registering the user in the application 202, for use of the application 202 by the user. For application registration, the user inputs the registration information, through the key input unit 214, into registration information input items on an application registration image displayed in the display by the application 202.

The registration information contains an IDentification (ID) and a password to be used for the application 202 by the user, and information on a user's account registered in the server 100. The user accesses a server site related to the server 100 to make and register the account in the server 100 before performing application registration in the application 202.

When the platform 204 receives the registration request from the application, the platform 204 accesses the server 100 through the communication unit 206 and sends a registration request message to the server 100, in step 402. The server 100 is a server that is set in advance by a developer of the application 202. Specifically, the developer of the application 202 presets that the application 202 is provided the storage space from the server 100. The registration request message enables the terminal to be allocated the storage space of the application 202 for the user, according to the registration information. The registration request message contains the registration information received through the application 202, and an application ID.

The application ID is an ID preregistered in the server 100, by the developer of the application 202, through a server site that provides the server 100, which enables the platform 204 and the server 100 to distinguish the application 202 from other applications. Specifically, application IDs can be preset in the server 100 by respective developers of applications in order to enable the various applications to be identified when they are executed after being installed in the terminals 104 and 106, shown in FIG. 1. Accordingly, the same application is assigned the same application ID even though the application is executed in another terminal, and different applications are assigned different application IDs even though they are executed in the same terminal.

When the controller 300 of the server 100 receives the registration request message from the terminal 104 through the communication unit 304 in step 402, in step 404, the controller 300 registers the user according to the registration information of the user relevant to the application 202, such that the user corresponds to the application 202. The controller 300 identifies the application 202 through the application ID contained in the registration request message, and identifies the user through account information among the registration information of the user contained in the registration request message. Further, when the controller 300 registers the user such that the user corresponds to the application 202, the controller 300 assigns a user ID to the user. The controller 300 stores a current registration state showing the user relevant to the application 202, which is registered in accordance with the application 202, in the memory 306 and manages the stored current registration state.

The controller 300 generates the storage space for the user in the storage 102, such that the storage space corresponds to the application 202, in step 406. Specifically, the controller 300 generates the storage space for the user such that the storage space corresponds to the user ID and the application ID of the application 202. The controller 300 generates the storage space in the storage 102 with an attribute preset in the server 100 such that the attribute corresponds to the application ID.

The attribute in the storage space is preset in the server site related to the server 100 by the developer of the application 202. The attribute includes a data type and a key name. Different kinds of data types include, for example, “ing”, “int”, “double”, etc. for designating a type of a data value stored in the database. The key name defines a key to be used for access to the storage space by the user. The number of key names may be designated by the server 100.

The controller 300 transmits a registration completion message to the terminal 104 through the communication unit 304, in step 408. The registration completion message represents completion of registration of the user corresponding to the application 202. The registration completion message contains a user ID.

When the platform 204 of the terminal 104 receives the registration completion message from the server 100 through the communication unit 206, the platform 204 sends a registration completion message informing the application 202 of the completion of registration of the user corresponding to the application 202, in step 410. Then, the application 202 completes an application registration for the user, and informs the user of the completion of application registration through the display 212.

The platform 204 stores the user ID contained in the registration completion message in the memory 210, in accordance with the application 202. The stored user ID is used when the user requests access to the storage space to the server 100, as described in greater detail below.

FIG. 5 is a diagram illustrating storage space generation, according to an embodiment of the present invention. FIG. 5 shows logical storage spaces generated in the storage 102 by the controller 300 of the server 100, through repetitive processes of FIG. 4 performed by multiple users of multiple applications. Referring to FIG. 5, storage spaces are generated for different users A1, A2, . . . , An, B1, B2, . . . , Bm corresponding to different applications 1, 2, . . . , k, respectively. When a new user of one application of the applications 1, 2, . . . , k or a new user of another application other than the applications 1, 2, . . . , k is registered in the server 100, a new storage space corresponding to the new user is generated.

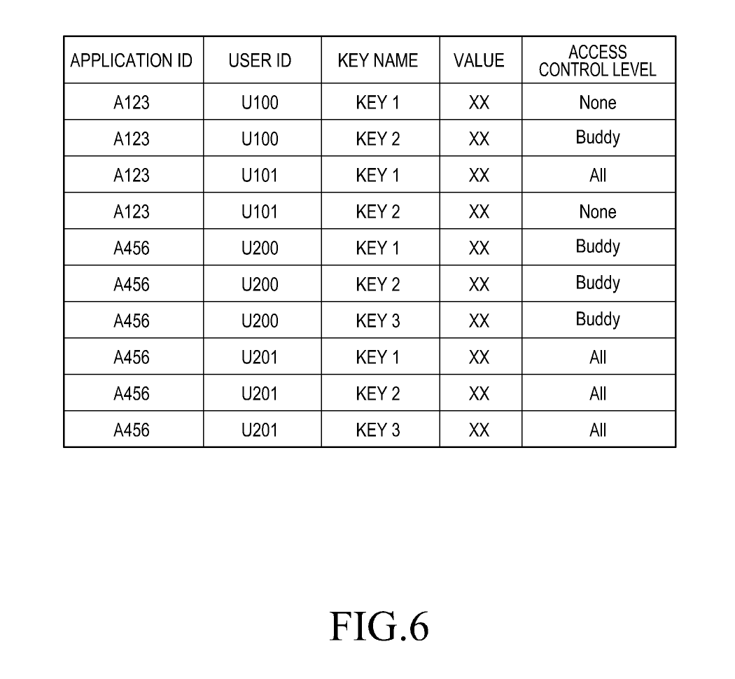

FIG. 6 is a chart illustrating a database, according to an embodiment of the present invention. FIG. 6 shows an embodiment of the present invention in which values corresponding to respective key names are stored as data, when the storage spaces generated as shown in FIG. 5 are accessed according to the processes of FIG. 4 by the users of the applications. The access may be one of “read”, “write”, and “search”, and is implemented using the key name as a key. The “read” access is a function of reading a stored value corresponding to the key name from the database. The “write” access is a function of writing the value corresponding to the key name in the database. The “search” access is a function of searching for the value corresponding to the key name.

Referring to FIG. 6, an application with an application ID “A123” has generated storage spaces corresponding to users with a user ID “U100” and a user ID “U101”. An application with an application ID “A456” has generated storage spaces corresponding to users with a user ID “U200” and a user ID “U201”. Further, values corresponding to key names “key 1” and “key 2” are stored for the application with the application ID “Al23”. Values corresponding to key names “key 1”, “key 2” and “key 3” are stored for the application with the application ID “A456”. For example, if the application with the application ID “A123” is an application for storing information on a user's body in the external storage space as user information, the “key 1” may be a “weight” and the “key 2” may be a “height”. As another example, when the application with the application ID “A456” is a game related application for storing game related information of the user in the external storage space as the user information, the “key 1” may be a “user grade”, the “key 2” may be a “game level”, and the “key 3” may be a “score”.

The user can set an access control level for determining whether another user's access to data of values corresponding to the key names is allowed. As shown in FIG. 6, the access control level can be set to one of “None”, “Buddy”, and “All”. The “None” access control level indicates that the access control level is not set, the “Buddy” access control level indicates that only an access of another user, which the user designates, is allowed, and the “All” access control level indicates that accesses of all other users are allowed. In order to prevent the values stored as shown in FIG. 6 from being changed by another user, only the “read” and “search” accesses are allowed for an access of another user.

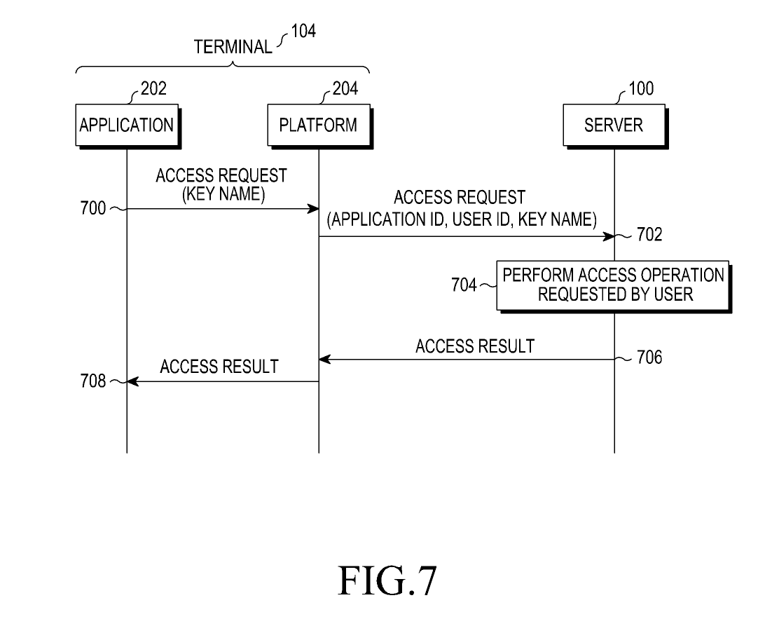

FIG. 7 is a flowchart illustrating a storage space access methodology, according to an embodiment of the present invention. The flowchart of FIG. 7 shows processes performed between the controller 200 of the terminal 104 and the controller 300 of the server 100 that enables the terminal 104 to access the storage space, that is, the database shown in FIG. 6, in response to an access request of the user relevant to the application 202. In FIG. 7, processes performed by the controller 200 of the terminal 104 are divided into processes performed by the application 202 and processes performed by the platform 204.

Referring to FIG. 7, when the application 202 executed through the controller 200 by the user receives an access request from the user through the key input unit 214, the application 202 sends the access request to the platform 204, in step 700. The access request includes a key name input by the user, and includes one of “read”, “write”, and “search” as an access instruction. The user accesses the storage space by using the key name as the key.

When the platform 204 receives the access request from the application 202, the platform 204 accesses the server 100 through the communication unit 206 and sends an access request message to the server 100, in step 702. The access request message includes the application ID of the application 202, the user ID assigned by the server 100, and the key name and the access instruction input by the user.

When the controller 300 of the server 100 receives the access request message from the terminal 104, the controller 300 performs an access operation based on the key name, in step 704. The access operation is one of “read”, “write”, and “search” requested by the user.

The controller 300 of the server 100 sends an access result message, which includes an access result, to the terminal 104 through the communication unit 304, and the platform 204 of the terminal 104 receives the access result message from the server through the communication unit 206, in step 706. The platform 204 transfers the access result to the application 202, in step 708, and the application 202 displays the access result for the user through the display 212.

As described above, the storage for the user, corresponding to the application executed in the terminal, is generated in the storage of the server in accordance with the application ID and the user ID. The terminal accesses the storage space generated in the storage of the server with a combination of the application ID, the user ID, and the key name.

Since the access to the external storage space is implemented with only the application ID and the user ID, it is possible to naturally ensure security at a simple level without additional access control logic, and easy access by the application can be achieved. Further, a simple implementation for sharing user information between users of the applications can be achieved.

Although the embodiments of the present invention have shown that the user information stored in the storage space can be shared between users of various applications, the user information may also be shared between users of a certain application in an embodiment of the present invention. Further, the setting of the access control level may be omitted.

The embodiments of the present invention can be implemented in a form of hardware, software, or a combination of the hardware and the software. For example, the software can be stored in volatile or nonvolatile storage devices, such as a Read Only Memory (ROM), a Random Access Memory (RAM), etc., or in optically or magnetically recordable and machine-readable storage media such as a Compact Disc (CD), a Digital Versatile Disc (DVD), a magnetic disc, magnetic tape, etc. Accordingly, the embodiments of the present invention include a program having a code for implementing the apparatus or the method described herein and a machine (computer, etc.) readable storage medium for storing the program. Further, the program can be electronically transferred though an arbitrary medium such as a communication signal transmitted through a wired or wireless connection, and the embodiments of the present invention properly include equivalents.

The terminal can use a program (e.g., an application) for providing the storage space of the application by downloading the program from a remotely located program providing apparatus (e.g., a server) or installing and executing the program. Specifically, when the program for providing the storage space of the application is installed in the terminal, the program is executed in the terminal and can provide the storage space of the application. The program providing apparatus transmits the program to the terminal automatically, or in response to a transmission request for the program by the terminal. The program providing apparatus can additionally determine whether the terminal subscribes to a service, or perform the identification of information on a user authentication and a payment. The program providing apparatus may include a communication unit for performing wired or wireless communication with the terminal, a storing medium for storing the program, and a controller for transmitting the program to the terminal by the communication unit. The storing medium can be located inside or outside of the program providing apparatus. According to embodiments of the present invention, the external storage space of the application is generated in accordance with the application and the user, and the external storage space is accessed by the user through an interworking between the terminal and the server preset for the specific application.

Therefore, a simple level of the security is naturally ensured without an additional access control logic, and easy application access can be achieved. Further, a simple implementation for sharing the user information between users of the applications can be achieved.

As a result, application developers can easily develop applications. While the invention has been shown and described with reference to certain embodiments thereof, it will be understood by those skilled in the art that various changes in form and details may be made therein without departing from the spirit and scope of the invention as defined by the appended claims.

What is claimed is:

1. A control method of a terminal for providing an external storage space of an application executed in the terminal, the control method comprising the steps of:
receiving registration information of a user through the application via an application registration request of the user;
transmitting a registration request message to a server preset for the application, wherein the registration request message requests allocation of a storage space for the user in the server according to the registration information, and wherein the storage space corresponds to the application;
receiving a registration completion message from the server; and
informing the user of completion of an application registration through the application, when the registration completion message is received from the server.

2. The control method as claimed in claim 1, wherein the registration information comprises information on an account of the user registered in the server, the registration request message comprises the registration information and an application IDentification (ID) of the application, the registration completion message comprises a user ID assigned to the user by the server, and the storage space is generated to correspond to the application ID and the user ID.

3. The control method as claimed in claim 2, wherein the storage space is generated with an attribute preset in the server, the attribute corresponds to the application ID, and the attribute comprises a key name for use as a key to access to the storage space by the user.

4. The control method as claimed in claim 3, further comprising:
receiving an access request of the user through the application, wherein the access request comprises the key name;
transmitting an access request message to the server, wherein the access request message comprises the application ID, the user ID, and the key name;
receiving an access result from the server in response to the access request message; and
providing the access result to the user through the application.

5. The control method as claimed in claim 4, wherein an access control level is set by the user for data stored in the storage space of the user, wherein the access control level defines whether access by another user is allowed.

6. A control method of a server for providing an external storage space of an application executed in a terminal, the server being preset for the application, the control method comprising the steps of:
receiving a registration request message from the terminal, wherein the registration request message comprises registration information of a user of the application;
registering the user according to the registration information such that the user corresponds to the application;
generating a storage space for the user in a storage such that the storage space corresponds to the application; and
transmitting a registration completion message to the terminal, wherein the registration completion message indicates completion of registration of the user corresponding to the application.

7. The control method as claimed in claim 6, wherein the registration information comprises information on an account of the user registered in the server, the registration request message comprises the registration information and an application IDentification (ID) of the application, the registration completion message comprises a user ID assigned to the user by the server, and the storage space is generated to correspond to the application ID and the user ID.

8. The control method as claimed in claim 7, wherein the storage space is generated with an attribute preset in the server, the attribute corresponds to the application ID, and the attribute comprises a key name for use as a key to access to the storage space by the user.

9. The control method as claimed in claim 8, further comprising:
receiving an access request message from the terminal, wherein the access request message comprises the application ID, the user ID, and the key name;
performing an access operation for the storage space corresponding to the application ID and the user ID based on the key name; and
transmitting an access result to the terminal, when the access operation is completed.

10. The control method as claimed in claim 9, wherein an access control level is set by the user for data stored in the storage space of the user, wherein the access control level defines whether access by another user is allowed.

11. A terminal for providing an external storage space of an application executed in the terminal, the terminal comprising:
a communication unit for providing communication to a preset server for the application; and
a controller for receiving registration information of a user through the application via an application registration request of the user, transmitting a registration request message to the preset server through the communication unit, wherein the registration request message requests allocation of a storage space for the user in the server according to the registration information, and wherein the storage space corresponds to the application, receiving a registration completion message from the server through the communication unit, and informing the user of completion of an application registration through the application when the registration completion message is received from the server.

12. The terminal as claimed in claim 11, wherein the registration information comprises information on an account of the user registered in the server, the registration request message comprises the registration information and an application IDentification (ID) of the application, the registration completion message comprises a user ID assigned to the user by the server, and the storage space is generated to correspond to the application ID and the user ID.

13. The terminal as claimed in claim 12, wherein the storage space is generated with an attribute preset in the server, the attribute corresponds to the application ID, and the attribute comprises a key name for use as a key to access to the storage space by the user.

14. The terminal as claimed in claim 13, wherein the controller receives an access request of the user through the application, wherein the access request comprises the key name, transmits an access request message to the server through the communication unit, wherein the access request message comprises the application ID, the user ID, and the key name, receives an access result from the server through the communication unit in response to the access request message, and providing the access result to the user through the application.

15. The terminal as claimed in claim 14, wherein an access control level is set by the user for data stored in the storage space of the user, wherein the access control level defines whether access by another user is allowed.

16. A server for providing a storage space of an application executed in a terminal, the server being preset for the application, the server comprising:
a communication unit for providing communication to the terminal;
a storage for providing the storage space of the application; and
a controller for receiving a registration request message from the terminal through the communication unit, wherein the registration request message comprises registration information of a user of the application, registering the user according to the registration information such that the user corresponds to the application, generating the storage space for the user in the storage, and transmitting a registration completion message to the terminal through the communication unit, wherein the registration completion message indicates completion of registration of the user corresponding to the application.

17. The server as claimed in claim 16, wherein the registration information comprises information on an account of the user registered in the server, the registration request message comprises the registration information and an application IDentification (ID) of the application, the registration completion message comprises a user ID assigned to the user by the server, and the storage space is generated to correspond to the application ID and the user ID.

18. The server as claimed in claim 17, wherein the storage space is generated with an attribute preset in the server, the attribute corresponds to the application ID, and the attribute comprises a key name for use as a key to access to the storage space by the user.

19. The server as claimed in claim 18, wherein the controller receives an access request message from the terminal through the communication unit, wherein the access request message comprises the application ID, the user ID, and the key name, performs a requested access operation for the storage space corresponding to the application ID and the user ID based on the key name, and transmits an access result to the terminal through the communication unit when the access operation is completed.

20. The server as claimed in claim 19, wherein an access control level is set by the user for data stored in the storage space of the user, wherein the access control level defines whether access by another user is allowed.
